(19) United States
(12) Patent Application Publication
(10) Pub. No.: US 2026/0048775 A1
(43) Pub. Date: Feb. 19, 2026

(54) LOCKING STRUCTURE AND MOBILE WORKSTATION

(71) Applicant: TILTA INC., Burbank, CA (US)

(72) Inventors: Sen WU, Shenzhen (CN); Shuangqiang YANG, Shenzhen (CN); Wenping ZENG, Shenzhen (CN); Kefeng ZHOU, Shenzhen (CN)

(21) Appl. No.: 19/299,000

(22) Filed: Aug. 13, 2025

(30) Foreign Application Priority Data
Aug. 16, 2024 (CN) 2024219995453
Aug. 16, 2024 (CN) 2024220070947

(51) Int. Cl. B62B 3/02; B62B 3/00

(52) U.S. Cl. CPC B62B 3/022; B62B 3/005

(57) ABSTRACT

The present disclosure provides a locking structure and a mobile workstation, configured to connect a first component and a second component. The locking structure includes a retaining protrusion and a locking assembly. The retaining protrusion can be disposed on the first component. The locking assembly includes a trigger, a locking member, and an anti-detachment member. The locking member is rotatably connected to the second component, and the trigger is connected to the locking member. The anti-detachment member is elastically disposed on the second component. The trigger is movable relative to the second component to cause the locking member to rotate and engage with the retaining protrusion. The anti-detachment member can abut against the trigger to lock the trigger in place.

### CROSS-REFERENCE TO RELATED APPLICATIONS

The present application for patent claims priority to and the benefit of pending Chinese Application No. 2024220070947, filed on Aug. 16, 2024 and Chinese Application No. 2024219995453, filed on Aug. 16, 2024, and hereby expressly incorporated by reference herein as if fully set forth below in its entirety and for all applicable purposes.

### TECHNICAL FIELD

The present disclosure pertains to the technical field of expansion accessories, more particularly to a locking structure and a mobile workstation.

### INTRODUCTION

In daily life, a mobile workstation serves as an auxiliary vehicle, typically designed for work or outdoor activities. For instance, users can load photographic accessories onto the mobile workstation in specific scenarios.

Conventional mobile workstations generally include multiple storage platforms connected by support columns, with wheels installed on the bottom storage platform for mobility. Workers typically place photographic accessories on these storage platforms. Current mobile workstations, despite offering convenience for placing various items, lack portability for users.

### BRIEF SUMMARY

Aspects of the present disclosure provide a locking structure and a mobile workstation, which address the technical problem in related art where mobile workstations, while convenient for item placement, pose difficulties for users in terms of transportation.

Some aspects of the disclosure provided:
A locking structure, configured to connect a first component and a second component, includes:
a retaining protrusion, which can be arranged on the first component;
a locking assembly, including a trigger, an anti-detachment member, and a locking member. The locking member is rotatably attached to the second component. The second component features a first groove, with one end of the trigger connected to the locking member and the other end extending outside the second component through the first groove. The anti-detachment member is elastically positioned on the second component. The trigger can activate the locking member to rotate and secure onto the retaining protrusion, while the anti-detachment member can press against the trigger to lock it in position.

With the locking structure of this disclosure, when a user requires the use of the portable mobile workstation, the first storage box can be aligned and attached to the second storage box. The trigger can be rotated towards the anti-detachment member, causing the locking member to rotate relative to the second component and engage with the retaining protrusion. The anti-detachment member prevents disengagement. Specifically, during the locking process, the user can move the anti-detachment member to retract it relative to the trigger and then release it. Under elastic force, the anti-detachment member resets and presses against the trigger to secure it, ensuring the locking member remains stably engaged with the retaining protrusion. This locks the first and second storage boxes together, enabling compact storage for easy transportation. When the user needs to utilize the mobile workstation, the anti-detachment member can be disengaged to release the trigger, allowing the locking member to reset reversely and enabling the first and second storage boxes to be separated and reassembled into a multi-tiered mobile workstation. In summary, the mobile workstation of this disclosure combines portability with functional convenience for users.

### BRIEF DESCRIPTION OF THE DRAWINGS

The following provides a brief description of the accompanying drawings for implementing exemplary embodiments of the present disclosure. These drawings illustrate only exemplary embodiments, and various alternative configurations can be devised by those skilled in the art without inventive effort.

FIG. 1 is a diagram illustrating a mobile workstation according to some aspects of the present disclosure.

FIG. 2 is a diagram illustrating the mobile workstation folded into a compact case according to some aspects of the present disclosure.

FIG. 3 is a diagram illustrating a first storage box according to some aspects of the present disclosure.

FIG. 4 is an enlarged view of section A in FIG. 3.

FIG. 5 is a cross-sectional view of a second storage box according to some aspects of the present disclosure.

FIG. 6 is an enlarged view of section B in FIG. 5.

FIG. 7 is a cross-sectional view of the mobile workstation in the folded state.

FIG. 8 is an enlarged view of section C in FIG. 7.

FIG. 9 is an enlarged view of section D in FIG. 7.

FIG. 10 is a diagram illustrating a locking structure according to some aspects of the present disclosure.

FIG. 11 is an exploded view of the locking structure in the unlocked state.

FIG. 12 is an exploded view of the locking structure in the locked state.

FIG. 13 is a diagram illustrating a second storage box according to some aspects of the present disclosure.

### REFERENCE NUMERALS

100. mobile workstation; 10. locking structure; 20. first storage box; 201. support column; 202. clamping buckle; 2021. pipe clamp; 20211. locking end; 20212. locking portion; 20213. locking wrench; 203. storage space; 204. first annular groove; 205. second limiting notch; 206. second annular groove; 30. second storage box; 301. connecting base; 3011. first connecting portion; 3012. second connecting portion; 3013. first mounting space; 302. box body; 3021. box peripheral plate; 303. first groove; 3031. first groove body; 3032. second groove body; 40. wheel; 50. handle; 501. sliding groove; 502. first limiting member; 503. second limiting member; 60. movable wheel;
1. retaining protrusion;
2. locking assembly; 21. trigger; 211. connecting rod; 212. trigger button; 2121. first boss; 22. anti-detachment member; 221. second boss; 222. mounting block; 23. locking member; 231. locking portion; 2311. first limiting notch; 2312. protrusion; 2313. screw; 2314. washer; 2315. locking hook; 232. first elastic member.

### DETAILED DESCRIPTION

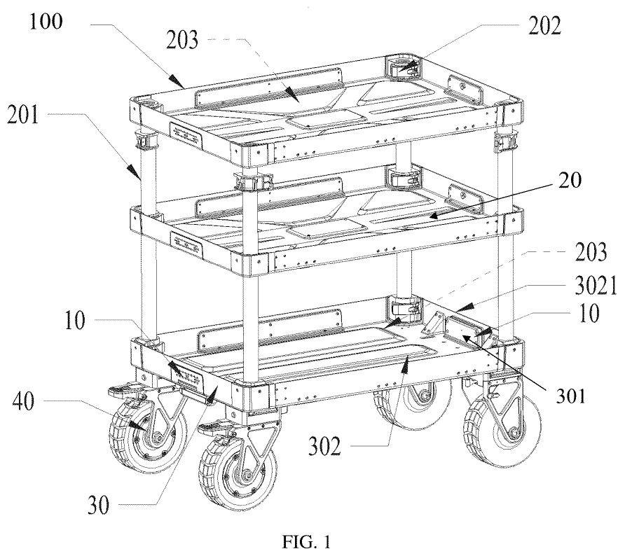

Referring to FIG. 1, this disclosure provides a portable mobile workstation 100, which can serve as a photography utility cart. The mobile workstation includes one or more support columns 201, one or more storage boxes (e.g., a first storage box 20, a second storage box 30), and a locking structure 10. For example, the locking structure 10 is designed to connect the first storage box 20 and second storage box 30, enabling them to form a compact, suitcase-like case. This arrangement not only reduces the overall volume of both the first storage box 20 and second storage box 30 for storage but also combines the storage spaces 203 of the first storage box 20 and second storage box 30 to create a portable compartment after locking them. Users can place necessary items inside this compartment and unlock the locking structure 10 when needed to access the items from this compartment after unlocking both the first storage box 20 and second storage box 30.

The support column 201 is detachably mounted on the second storage box 30 via clamping buckles 202, while the first storage box 20 is detachably mounted on the support column 201 in a stacked arrangement via clamping buckles 202. Each storage box includes a storage space 203 for holding items. In some aspects, the detachable configuration allows the support column 201 to be completely removed from the first storage box 20 and second storage box 30 and placed inside the portable compartment. In one example, the support column 201 can be completely removed from the first storage box 20, but for the second storage box 30, the bottom of support column 201 can remain pivotally connected to the second storage box 30. In another example, when the support column 201 is removed relative to the second storage box 30 via clamping buckles 202, enabling it to be folded down relative to the first storage box 20 into the storage space 203 of the first storage box 20. In summary, when the user needs to utilize the mobile workstation 100, the support column 201 can be secured by the clamping buckles 202 installed on the first storage box 20 and the second storage box 30, ensuring that the first storage box 20 and the second storage box 30 are stably mounted onto the support column 201, thereby facilitating user operation.

A plurality of wheels 40 can be rotatably provided on the side of the second storage box 30 opposite to the first storage box 20, enhancing mobility for work-related use, allowing the mobile workstation 100 to be easily moved across the filming site. When the user needs to relocate to a different filming site, the portable mobile workstation 100 described herein can be disassembled for transport. In some aspects, the support column 201 can be stowed within the storage space 203 of the second storage box 30, while the first storage box 20 can be inverted and placed over the second storage box 30, with the two securely fastened together via the locking structure 10. Additional items, such as filming equipment or other components of the mobile workstation 100, can also be stored within the storage spaces 203 of the first storage box 20 and the second storage box 30.

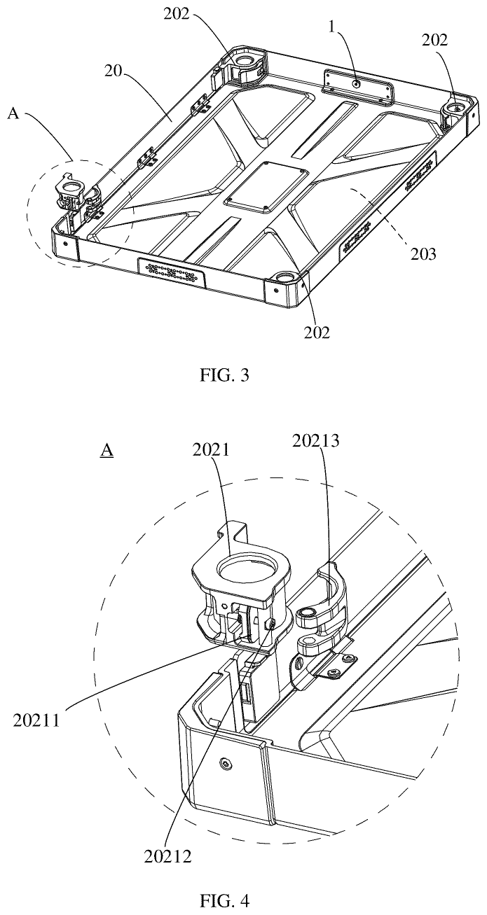

Referring to FIGS. 3-4, both the first storage box 20 and the second storage box 30 are equipped with clamping buckles 202. For example, the clamping buckle 202 can include a pipe clamp 2021 designed to mount the support column 201 therein. Taking the first storage box 20 as an example, the clamping buckle 202 can be positioned on the first storage box 20. The pipe clamp 2021 includes a movable locking end 20211 at one end and a locking portion 20212. One end of the locking portion 20212 is threadedly connected to the pipe clamp 2021, while the other end passes through the locking end 20211 and is movably connected to an locking wrench 20213. When the locking wrench 20213 is tightened, its locking head presses against the locking end 20211 of the pipe clamp 2021, causing the locking end 20211 to move and clamp the support column 201, thereby completing the locked installation of the support column 201 and the second storage box 30. The locking mechanism of the clamping buckle 202 on the second storage box 30 is identical to that on the first storage box 20 and will not be elaborated here.

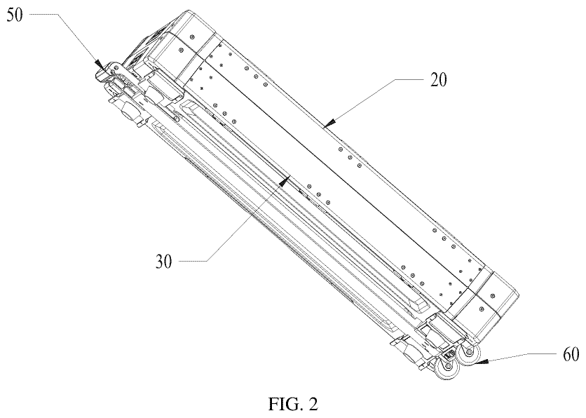

Referring to FIG. 2, on the one hand, the mobile workstation 100 can include a handle 50 and movable wheels 60. The movable wheels 60 are positioned on the outer side of the second storage box 30, and the handle 50 is mounted at the end of the second storage box 30 opposite to the movable wheels 60. After locking the first storage box 20 and the second storage box 30 together, the user can grip the handle 50 to pull and move the folded mobile workstation 100. In some aspects, the movable wheels 60 facilitate the mobility function. The aforementioned multiple wheels 40 can be installed in a quick-release manner, enabling rapid detachment from or attachment to the second storage box 30. The detached wheels 40 can be stored in the portable compartment. On the other hand, the folded mobile workstation 100 facilitates loading onto vehicles, among other scenarios. It should be noted that the quick-release manner for the wheels 40 can adopt existing solutions in the field, such as standardized quick-release mechanism, and is therefore not described in detail herein.

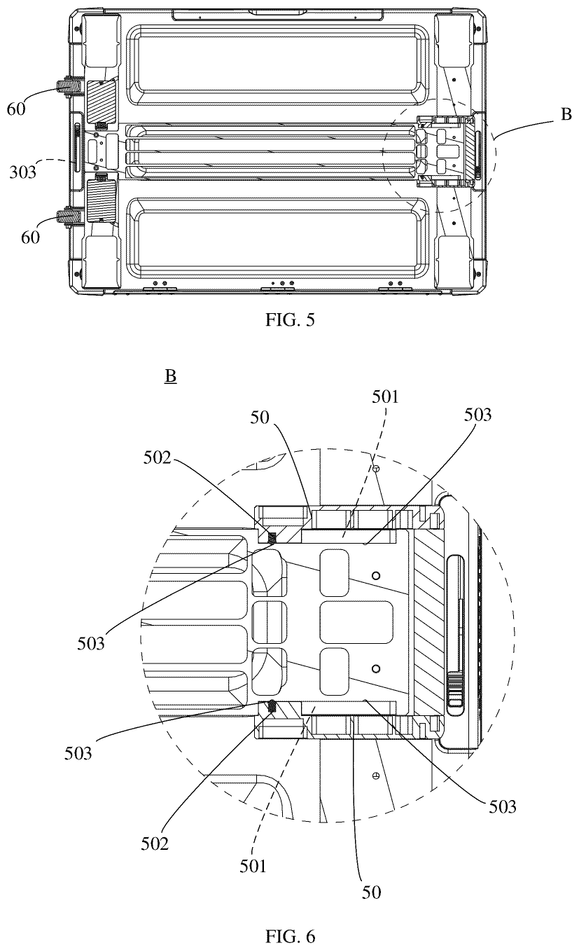

Referring to FIGS. 5-6, the side of the second storage box 30 facing away from the first storage box 20 can be equipped with a sliding groove 501. The handle 50 is slidably mounted in the sliding groove 501 and is fitted with a first limiting member 502. The groove wall of the sliding groove 501 can be equipped with multiple second limiting members 503, which can restrict the movement of the first limiting member 502 to limit the displacement of the handle 50. In one example, the first limiting member 502 can be an elastically mounted detent ball, while the second limiting members 503 can be one or more limiting holes. The detent ball can slide along the sliding groove 501 and engage in different limiting holes to complete the positioning process. For example, when the user needs to operate the workstation, the handle 50 can be pulled out along the sliding groove 501, and the detent ball can engage with one of the limiting holes, securing the handle 50 in the extended position. The user can then pull the combined case formed by the first storage box 20 and the second storage box 30 for mobility.

In some aspects, the mobile workstation 100 can incorporate multiple storage boxes connected by a support column 201, with wheels 40 installed on the bottom storage box to enable the mobile workstation 100 to move. During use, workers place photographic accessories in the storage boxes for convenient access and work efficiency. However, since conventional mobile workstations 100 often require substantial storage space 203, their overall size tends to be large, causing significant inconvenience during transport.

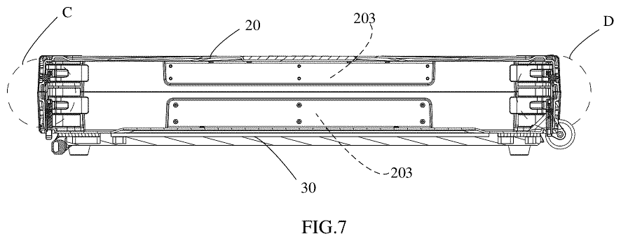

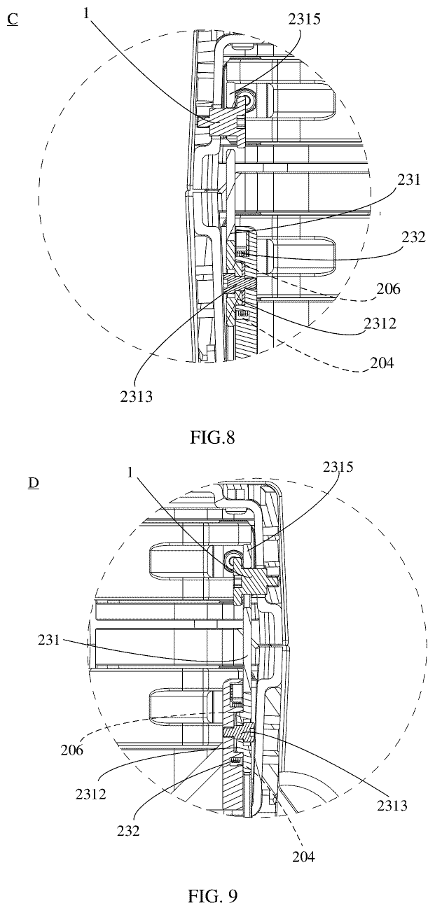

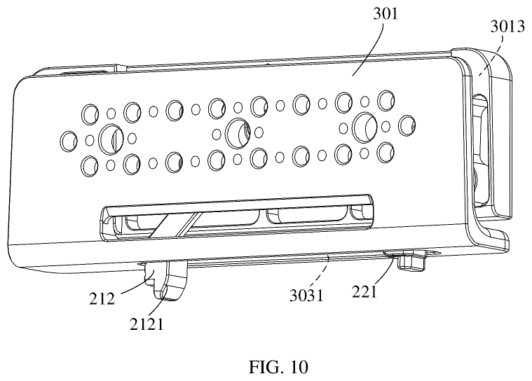

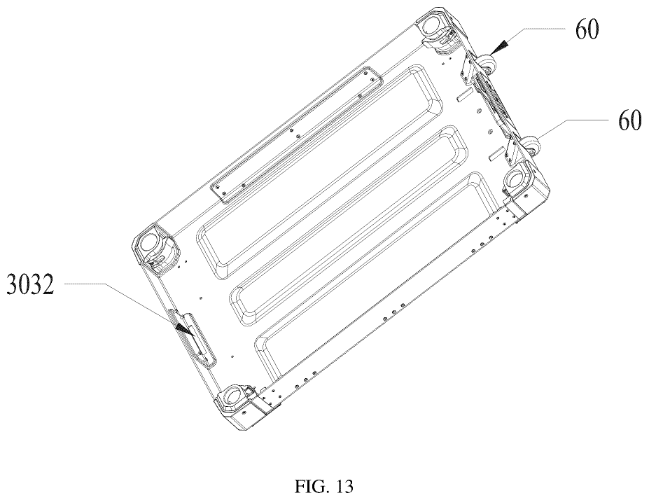

Referring to FIGS. 7-13. The locking structure 10 in this disclosure is designed to connect a first component and a second component. The locking structure 10 includes a retaining protrusion 1 and a locking assembly 2. The retaining protrusion 1 can be positioned on the first component. The locking assembly 2 includes a trigger 21, an anti-detachment member 22, and a locking member 23. The locking number 23 is rotatably attached to the second component. The trigger 21 is movable relative to the second component to drive the locking member 23 to rotate and engage with the retaining protrusion 1. The second component features a first groove 303. One end of the trigger 21 is connected to the locking member 23, while the other end extends outside the second component through the first groove 303. The anti-detachment member 22 is elastically mounted on the second component. The trigger 21 can activate the locking member 23 to rotate and secure onto the retaining protrusion 1, while the anti-detachment member 22 presses against the trigger 21 to lock it in position, thereby securing the first and second components together.

In the locking structure 10 of this disclosure, when the user intends to utilize the portable mobile workstation 100, the first storage box 20 can be aligned and attached to the second storage box 30. The trigger 21 is then rotated toward the anti-detachment member 22, prompting the locking member 23 to rotate relative to the second component and engage on the retaining protrusion 1. The anti-detachment member 22 serves to prevent disengagement. In one example, during the locking process, the user can retract the anti-detachment member 22 relative to the trigger 21 and subsequently release it. Under the influence of elastic force, the anti-detachment member 22 resets and abuts against the trigger 21 to secure it, thereby ensuring the stable engagement of the locking member 23 on the retaining protrusion 1. This action locks the first storage box 20 and the second storage box 30 together, facilitating compact storage for easy transportation of the mobile workstation 100. When the user needs to utilize the mobile workstation 100, the anti-detachment member 22 can be disengaged to release the trigger 21, allowing the locking member 23 to reversibly reset. Subsequently, the first storage box 20 and the second storage box 30 can be detached and reassembled into a multi-tiered mobile workstation 100. In summary, the mobile workstation 100 of this application combines portability with functional convenience for users. Here, the first component and second component can refer to either the first storage box 20 or the second storage box 30.

In some aspects, the trigger 21 includes a connecting rod 211 and a trigger button 212. The trigger button 212 can be housed within the first groove 303. One end of the connecting rod 211 is connected to the locking member 23, while the other end extends toward the first groove 303 and connects to the trigger button 212. The trigger button 212 is movable along the first groove 303 toward the anti-detachment member 22, causing the connecting rod 211 to rotate and drive the locking member 23 to lock onto the retaining protrusion 1. The anti-detachment member 22 abuts against the trigger button 212 to secure the trigger button 212 in place.

In some aspects, the trigger button 212 includes a first boss 2121, and the anti-detachment member 22 includes a second boss 221 and a mounting block 222. The mounting block 222 is elastically connected to the second storage box 30. The second boss 221 is connected to the mounting block 222, with at least part of its structure exposed outside the first groove 303. The second boss 221 can abut against the first boss 2121 to secure the first boss 2121 in place. In some aspects, the elastic connection between the mounting block 222 and the second storage box 30 can be achieved through a spring compressed or connected between them.

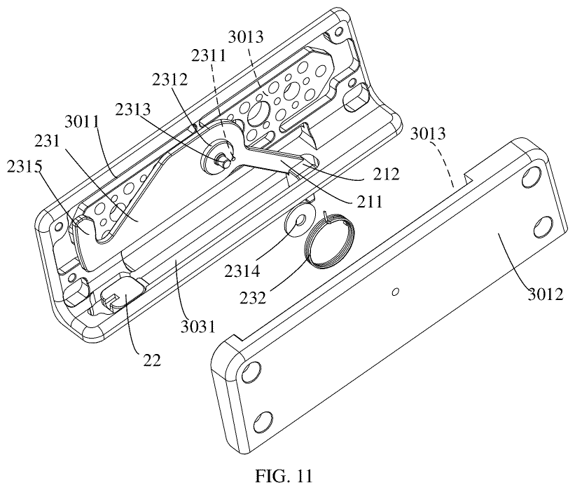

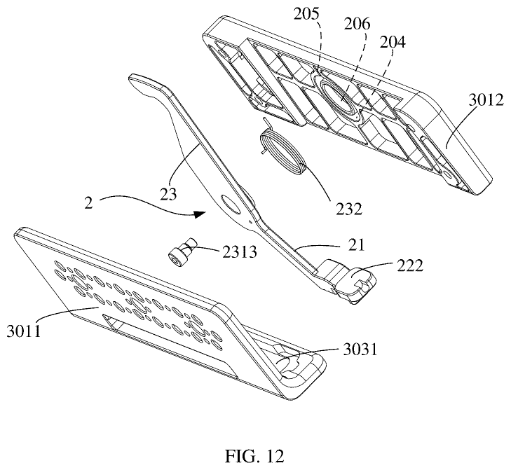

Referring to FIGS. 11-12, in some aspects, the locking member 23 includes a locking portion 231 and a first elastic member 232. The trigger 21 is connected to the locking portion 231, which is rotatably connected to the second component. The second component can be equipped with a first annular groove 204, and the first elastic member 232 is housed within the first annular groove 204. The first elastic member 232 is positioned between the locking portion 231 and the second component, with one end abutting or connected to the locking portion 231 and the other end abutting or connected to the second component. Taking the perspective of FIGS. 11-12 as an example, when the user moves the trigger 21 toward the right side of the drawing, the locking portion 231 is driven to rotate counterclockwise relative to the second storage box 30. In one example, the locking portion 231 is provided with a first limiting notch 2311, while the second component can be equipped with a second limiting notch 205. One end of the first elastic member 232 is engaged with the first limiting notch 2311, and the other end is engaged with the second limiting notch 205.

In some aspects, the side of the second component facing the locking portion 231 further includes a second annular groove 206. The first annular groove 204 and the second annular groove 206 are concentrically arranged. The side of the locking portion 231 facing the second component can be equipped with a protrusion 2312, which is movably disposed within the second annular groove 206. This configuration allows the groove wall of the second annular groove 206 to limit the rotation of the locking portion 231. In one example, a screw 2313 can pass through the second annular groove 206 and threadedly engage with the second component. The protrusion 2312 can be movably sleeved on the screw 2313, enabling rotation relative to the second component. A washer 2314 can be disposed between the protrusion 2312 and the bottom of the second annular groove 206.

Referring to FIGS. 11-13, the end of the locking portion 231 away from the trigger 21 includes a locking hook 2315. The trigger 21 can drive the locking portion 231 to move, causing the locking hook 2315 to engage with the retaining protrusion 1.

The second storage box 30 includes a connecting base 301 and a box body 302. The connecting base 301 is connected to the box peripheral plate 3021 of the box body 302. The locking member 23 is movably connected to the connecting base 301. Referring to FIG. 11, the anti-detachment member 22 is elastically mounted on the connecting base 301. The first groove 303 includes interconnected first groove body 3031 and second groove body 3032. The box body 302 can be equipped with the second groove body 3032, while the connecting base 301 can be equipped with the first groove body 3031. The end of the trigger 21 away from the locking member 23 can pass through the second groove body 3032 and the first groove body 3031, extending outside the connecting base 301. This configuration modularizes the box body 302 and the connecting block. The locking member 23 is movably connected to the connecting base 301, which is attached to the box body 302. During disassembly, removing the connecting block allows the locking structure 10 to be detached from the box body 302, facilitating replacement or maintenance. This design also enhances installation efficiency. For instance, during assembly, the locking structure 10 can first be installed onto the connecting block, which is then mounted onto the box body 302, completing the installation of the locking structure 10 in a modular fashion.

In some aspects, the second groove body 3032 is located on the bottom of the box body 302. The connecting base 301 includes a first connecting portion 3011 and a second connecting portion 3012, which are attached to the inner and outer sides of the box edge of the box body 302, respectively. A first mounting space 3013 is formed between the first connecting portion 3011 and the second connecting portion 3012. The box peripheral plate 3021 of the first storage box 20 and the locking member 23 are housed within this first mounting space 3013. The first groove body 3031 is provided on the first connecting portion 3011. The trigger 21 can pass through the second groove body 3032 and the first groove body 3031, extending outside the first connecting portion 3011. The trigger 21 actuates the locking member 23 to rotate such that its end away from the trigger 21 extends out of the first mounting space 3013, engaging with the retaining protrusion 1 to lock the first storage box 20 and the second storage box 30 together. This arrangement enhances installation stability and convenience. During assembly, the locking member 23 can first be mounted onto the second connecting portion 3012. The first connecting portion 3011 and the second connecting portion 3012 are then clamped onto the inner and outer sides of the box edge, respectively, ensuring a secure installation of the connecting base 301.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A locking structure configured to connect a first component and a second component, the locking structure comprising:
a retaining protrusion, configured to be provided on the first component;
a locking assembly comprising a trigger, a locking member, and an anti-detachment member, wherein the locking member is rotatably connected to the second component, and the trigger is connected to the locking member;
wherein the anti-detachment member is elastically provided on the second component;
wherein the trigger is movable with respect to the second component to rotate the locking member to engage with the retaining protrusion; and
wherein the anti-detachment member is configured to abut against the trigger so as to lock the trigger.

2. The locking structure according to claim 1, wherein the trigger comprises a connecting rod and a trigger button;
wherein one end of the connecting rod is connected to the locking member, and another end extends to connect to the trigger button;
wherein the trigger button is configured to move toward the anti-detachment member, causing the connecting rod to rotate and drive the locking member into engagement with the retaining protrusion; and
wherein the anti-detachment member is configured to abut against the trigger button to lock the trigger button.

3. The locking structure according to claim 2, wherein the trigger button comprises a first boss, and the anti-detachment member comprises a second boss and a mounting block;
wherein the mounting block is elastically connected to the second component; and
wherein the second boss is connected to the mounting block, and the second boss is configured to abut against the first boss to lock the first boss.

4. The locking structure according to claim 1, wherein the locking member comprises a locking portion and a first elastic member;
wherein the trigger is connected to the locking portion;
wherein the locking portion is rotatably connected to the second component, and the second component is provided with a first annular groove;
wherein the first elastic member is received in the first annular groove and disposed between the locking portion and the second component; and
wherein one end of the first elastic member abuts or connects to the locking portion, and another end abuts or connects to the second component.

5. The locking structure according to claim 4, wherein the second component is provided with a second annular groove facing the locking portion;
wherein the second annular groove is located inside the first annular groove; and
wherein the locking portion comprises a protrusion facing the second component, and the protrusion is movably provided in the second annular groove.

6. The locking structure according to claim 5, wherein the locking portion comprises a locking hook at an end away from the trigger; and
wherein the trigger is configured to drive the locking portion to move, enabling the locking hook to engage with the retaining protrusion.

7. A mobile workstation, comprising a first storage box, a second storage box, and the locking structure according to claim 1, wherein the locking structure is configured to connect the first storage box and the second storage box, and the first storage box and the second storage box are detachably mounted on a support column;
wherein the retaining protrusion is provided on the first storage box; wherein the locking member is rotatably connected to the second storage box, and the second storage box is provided with a first groove;
wherein an end of the trigger away from the locking member is configured to pass through the first groove and protrudes, extending outside the second storage box;
wherein the trigger is movable with respect to the second storage box to rotate the locking member to engage with the retaining protrusion; and
wherein the anti-detachment member is configured to abut against the trigger to lock the first storage box and the second storage box together.

8. The mobile workstation according to claim 7, wherein the second storage box comprises a connecting base and a box body;
wherein the connecting base is connected to a box peripheral plate of the box body;
wherein the locking member is movably connected to the connecting base;
wherein the anti-detachment member is elastically connected to the connecting base;
wherein the first groove comprises a first groove body and a second groove body in communication;
wherein the box body is provided with the second groove body, and the connecting base is provided with the first groove body; and
wherein an end of the trigger away from the locking member is configured to pass through the second groove body and the first groove body and protrudes, extending outside the connecting base.

9. The mobile workstation according to claim 8, wherein the second groove body is provided at a bottom of the box body;
wherein the connecting base comprises a first connecting portion and a second connecting portion;
wherein a first mounting space is formed between the first connecting portion and the second connecting portion;
wherein the box peripheral plate of the first storage box and the locking member are received in the first mounting space;
wherein the first groove body is provided on the first connecting portion, and the locking member is movably connected to the second connecting portion;
wherein the trigger is configured to pass through the second groove body and the first groove body and protrudes, extending outside the first connecting portion; and
wherein the trigger is configured to drive the locking member to rotate, enabling an end of the locking member away from the trigger to protrude from the first mounting space, securing the end of the locking member protruding from the first mounting space to the retaining protrusion.

10. The mobile workstation according to claim 8, the mobile workstation further comprising a handle and a movable wheel, wherein the movable wheel is disposed outside the second storage box; and
wherein the handle is mounted on an end of the second storage box away from the movable wheel.

11. The mobile workstation according to claim 8, further comprising a clamping buckle, wherein the clamping buckle is provided at a bottom of the first storage box to enable secure installation between the support column and the first storage box.

12. The mobile workstation according to claim 8, further comprising a clamping buckle, wherein the clamping buckle comprises a pipe clamp configured to mount the support column; and
wherein the clamping buckle is provided at a bottom of the second storage box to enable secure installation between the support column and the second storage box.

13. The mobile workstation according to claim 8, wherein the first storage box and the second storage box each comprise four corners respectively, the four corners of the first storage box and the four corners of the second storage box are each connected with one clamping buckle; and
wherein one end of each support column is mounted to the first storage box via one clamping buckle, and another end of each support column is mounted to the second storage box via one clamping buckle.

14. The mobile workstation according to claim 13, wherein the clamping buckle comprises a pipe clamp configured to mount the support column;
wherein the clamping buckle further comprises a locking wrench, a locking end, and a locking portion;
wherein the locking portion extends through the locking end;
wherein one end of the locking portion is connected to the pipe clamp, and another end of the locking portion is connected to the locking wrench; and
wherein the locking wrench is configured to press the locking end, causing the locking end to move and clamp the support column.

15. The mobile workstation according to claim 14, wherein the locking wrench extends in an arc along an outer periphery of the pipe clamp, so that a shape of the locking wrench conforms to a shape of the pipe clamp.
